(19) United States
(12) Patent Application Publication
(10) Pub. No.: US 2013/0287245 A1
(43) Pub. Date: Oct. 31, 2013

(54) LOUDSPEAKER WITH REINFORCED FRAME

(71) Applicant: HWANG-MIAW CHEN, Tu-Cheng (TW)

(72) Inventor: HWANG-MIAW CHEN, Tu-Cheng (TW)

(73) Assignee: HON HAI PRECISION INDUSTRY CO., LTD., Tu-Cheng (TW)

(21) Appl. No.: 13/551,628

(22) Filed: Jul. 18, 2012

(30) Foreign Application Priority Data
Apr. 27, 2012 (CN) 201210127731.3

(51) Int. Cl. H04R 1/00

(52) U.S. Cl. 381/398

(57) ABSTRACT

An exemplary loudspeaker includes a frame, a yoke engaged with the frame, a magnet fixed to the yoke, a magnet fixed inside the yoke, a diaphragm attached to the frame, and a voice coil attached to the diaphragm. The frame includes a flange and a supporting bracket. The flange includes two parallel straight portions and two curve portions connected between the two parallel straight portions respectively. The supporting bracket includes a main body, two first extending portions extending from the main body and fixed to the straight portions, two second extending portions extending from the main body and fixed to the curve portions, and a through hole defined in a center of the main body. The yoke is received in the through hole of the main body.

### BACKGROUND

1. Technical Field

The disclosure generally relates to electroacoustic transducers, and more particularly to a loudspeaker with a strong frame that can improve the sound quality of the loudspeaker.

2. Description of Related Art

With the continuing development of audio and sound technology, loudspeakers have been widely used in electronic devices such as mobile phones, computers, televisions and other devices providing audio capabilities.

A typical loudspeaker includes a frame, a diaphragm connected with the frame, a voice coil joined to the diaphragm, and a magnet provided inside the frame. The magnet compels the voice coil to oscillate, and the oscillating voice coil drives the diaphragm to push ambient air and thereby generate sound. However, the frame of the loudspeaker is thin and easily damaged during assembly of the loudspeaker. Furthermore, the frame is liable to oscillate with the voice coil and generate a noise, thereby reducing the sound quality of the loudspeaker.

What is needed, therefore, is a loudspeaker which can overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an assembled, isometric view of a loudspeaker in accordance with one embodiment of the disclosure.

FIG. 2 shows the loudspeaker of FIG. 1 inverted.

FIG. 3 is a cross sectional view of the loudspeaker of FIG. 1, taken along line thereof.

FIG. 4 is an exploded, isometric view of the loudspeaker of FIG. 2.

### DETAILED DESCRIPTION

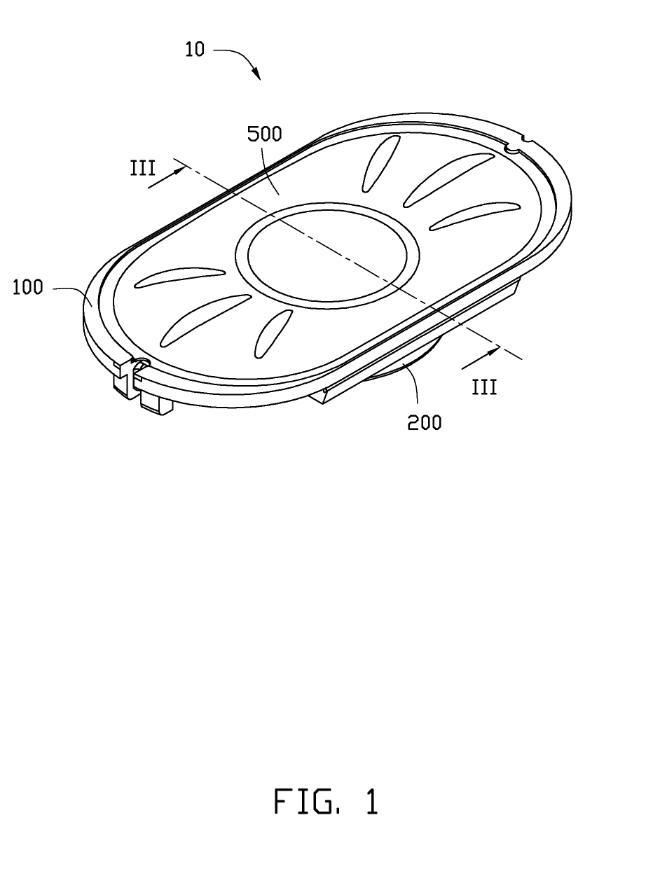

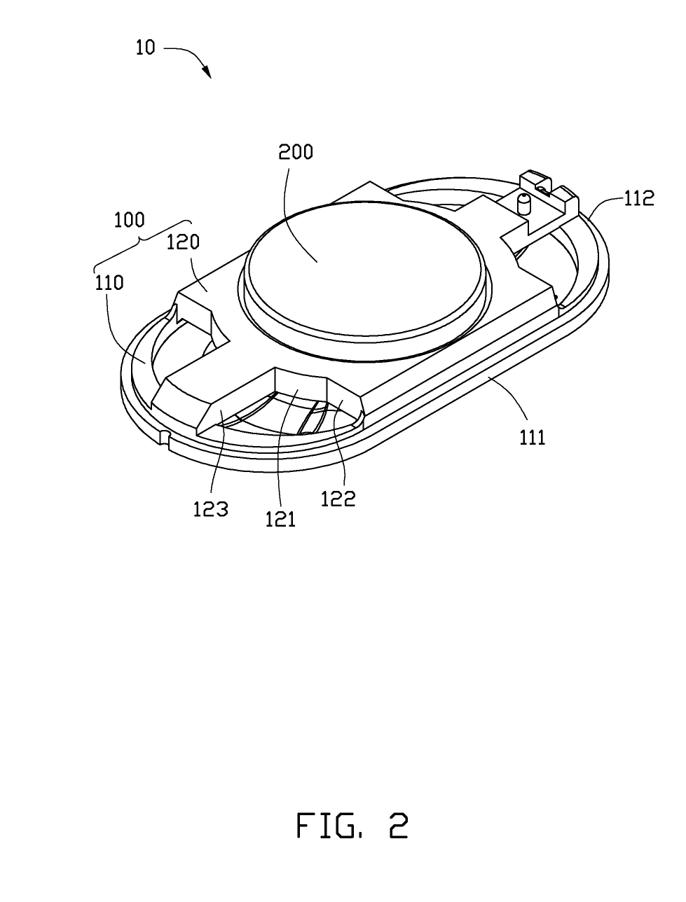

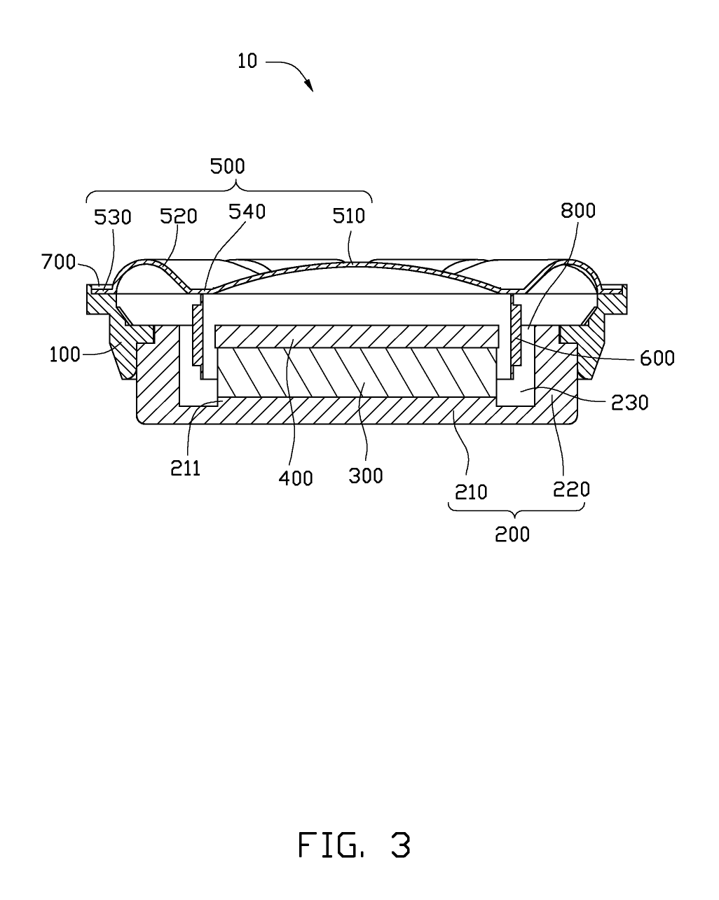

Referring to FIGS. 1-3, a loudspeaker 10 in accordance with one embodiment of the disclosure is shown. The loudspeaker 10 includes a frame 100, a yoke 200 engaged with the frame 100, a magnet 300 fixed to the yoke 200, a washer 400 located on the magnet 300, a diaphragm 500 attached to the frame 100, and a voice coil 600 attached to the diaphragm 500.

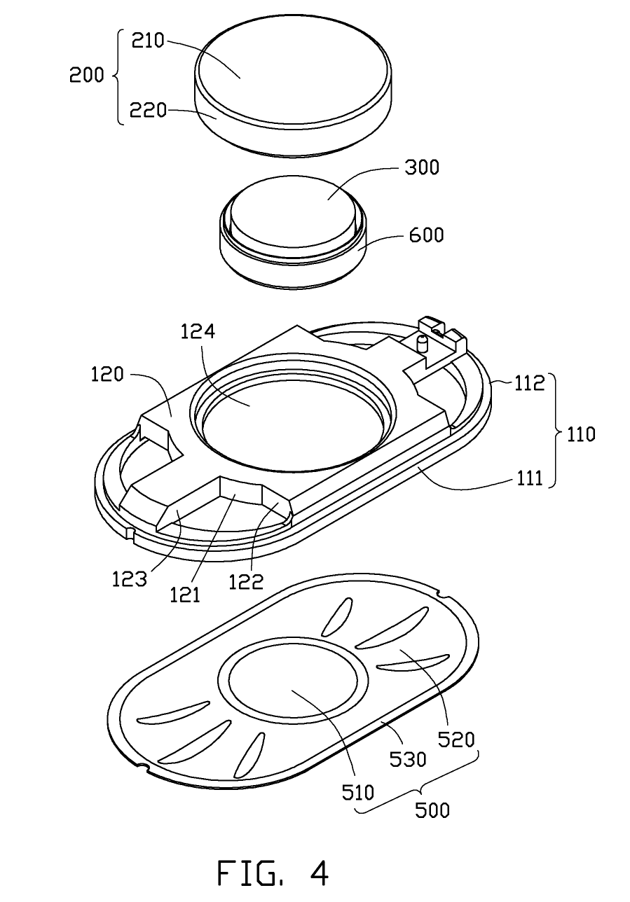

Referring also to FIG. 4, the frame 100 includes a flange 110 and a supporting bracket 120. The flange 110 generally has a raceway-shaped (or athletics track-shaped) structure, which includes two parallel straight portions 111 and two curve portions 112 connected between the two parallel straight portions 111, respectively. The supporting bracket 120 is secured to a bottom of the flange 110. The supporting bracket 120 includes a main body 121, two first extending portions 122 fixed to the straight portions 111, and two second extending portions 123 fixed to the curve portions 112. The main body 121, the two first extending portions 122 and the two second extending portions 123 together form a cross structure. A width of each of the first extending portions 122 along the corresponding straight portion 111 is larger than a width of each of the second extending portions 123 along a direction perpendicular to the straight portions 111. Because a rigidity of the straight portions 111 is less than that of the curve portions 112, the first extending portions 122 can increase the rigid intensity of the straight portions 111. A through hole 124 is defined through a center of the main body 121 of the supporting bracket 120. The through hole 124 is bounded by a step-shaped inner surface of the main body 121. In this embodiment, the flange 110 and the supporting bracket 120 are integrally formed as a single monolithic piece of material.

The yoke 200 includes a circular bottom plate 210, and a cylindrical side plate 220 extending upwardly from the bottom plate 210. The bottom plate 210 and the side plate 220 cooperatively define a receiving space 230 therebetween. A free end portion of the side plate 220 has a step-shaped structure, corresponding to the step-shaped inner surface of the main body 121 at the through hole 124. An outer diameter of the yoke 200 is substantially equal to an inner diameter of the through hole 124 inside the supporting bracket 120. The side plate 220 of the yoke 200 can be engaged in the through hole 124 of the supporting bracket 120, with an opening of the receiving space 230 oriented toward a top of the frame 100. The step-shaped inner surface of the main body 121 at the through hole 124 and the step-shaped structure of the side plate 220 can increase a contact area between the yoke 200 and the supporting bracket 120, whereby the yoke 200 is firmly connected to the supporting bracket 120. A platform 211 protrudes upwardly from a center of the bottom plate 210, for positioning the magnet 300.

The magnet 300 is received in the receiving space 230 of the yoke 200 and secured to the platform 211 of the bottom plate 210. The washer 400 is fixed on the magnet 300 to restrict a magnetic field generated by the magnet 300 within the yoke 200. Thereby, the magnetic field generated by the magnet 300 is limited between the washer 400 and the bottom plate 210 of the yoke 200, to strengthen an intensity of the magnetic field.

The diaphragm 500 is attached to an upper surface of the flange 110. The diaphragm 500 includes a central area 510 in a center thereof, a surrounding area 520 at an outer periphery of the central area 510, an annular inner joint portion 540 interconnecting the central area 510 and the surrounding area 520, and an annular outer joint portion 530 formed around and connected with the surrounding area 520. The annular outer joint portion 530 is firmly connected with the flange 110 by a ring 700, to secure the diaphragm 500 to the flange 110. That is, the ring 700 includes two parallel straight portions and two curve portions connected between the two parallel straight portions, respectively; with the shape and a size of the ring 700 corresponding to the shape and a size of the flange 110. A plurality of grooves is generally radially defined in the diaphragm 500, to increase a rigidity of the diaphragm 500.

The voice coil 600 is an annular electrically conductive coil. One end of the voice coil 600 is secured to a bottom of the annular inner joint portion 540 of the diaphragm 500. An opposite end of the voice coil 600 is inserted into an annular gap 800 between the side plate 220 of the yoke 200 and the magnet 300.

In operation of the loudspeaker 10, a driving current is applied to the voice coil 600, and the voice coil 600 generates a magnetic field. The magnetic field generated by the voice coil 600 and the magnetic field generated by the magnet 300 interact and compel the voice coil 600 to oscillate. The oscillating of the voice coil 600 drives the diaphragm 500 to push ambient air and thereby generate sound.

Because the frame 100 includes the flange 110 and the supporting bracket 120, the supporting bracket 120 can increase the rigid intensity of the flange 110 and help ensure that the frame 100 does not easily oscillate with the diaphragm 500 or even does not oscillate at all with the diaphragm 500. Therefore, noise generate by oscillating of the frame 100 is reduced or even eliminated, and the sound quality of the loudspeaker 10 is improved. In addition, with the supporting bracket 120, the frame 100 is not easily damaged in assembly of the loudspeaker 10. Furthermore, the bottom plate 210 defines the platform 211 at the center thereof. The platform 211 can increase a height of the gap 800 between the side plate 220 of the yoke 200 and the magnet 300, to help prevent the voice coil 600 from contacting the bottom plate 210 during oscillating of the voice coil 600. Moreover, the platform 211 can also act as an iron core to increase the magnet field of the magnet 300.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A loudspeaker, comprising:
a frame, which comprises a flange and a supporting bracket, the flange comprising two parallel straight portions and two curve portions connected between the two parallel straight portions respectively, the supporting bracket comprising a main body, two first extending portions extending from the main body and fixed to the straight portions, two second extending portions extending from the main body and fixed to the curve portions, and a through hole defined in a center of the main body;
a yoke engaged with the frame and at least partly received in the through hole of the main body;
a magnet fixed inside the yoke;
a diaphragm attached to the frame; and
a voice coil attached to the diaphragm.

2. The loudspeaker of claim 1, wherein the flange has a raceway-shaped structure.

3. The loudspeaker of claim 1, wherein the main body, the two first extending portions and the two second extending portions together form a cross structure.

4. The loudspeaker of claim 3, wherein a width of each of the first extending portions along the corresponding straight portion is larger than a width of each of the second extending portions along a direction perpendicular to the straight portions.

5. The loudspeaker of claim 1, wherein the flange and the supporting bracket are integrally formed as a single monolithic piece of material.

6. The loudspeaker of claim 1, wherein the yoke comprising a circular bottom plate and a side plate extending upwardly from the bottom plate, the bottom plate and the side plate cooperatively define a receiving space to receive the magnet.

7. The loudspeaker of claim 6, wherein a platform is defined at a center of the bottom plate for positioning the magnet.

8. The loudspeaker of claim 6, wherein the through hole has a step-shape inner surface, a free end portion of side plate of the yoke has a step-shape structure, corresponding to the step-shaped inner surface of the main body at the through hole.

9. The loudspeaker of claim 8, wherein one end of the voice coil is secured to the diaphragm, another terminal of the voice coil is inserted into a gap between the side plate of the yoke and the magnet.

10. The loudspeaker of claim 8, further comprising a washer fixed to the magnet, the washer being configured to restrict a magnetic field generated by the magnetic within the yoke, thereby the magnetic field generated by the magnet being limited between the washer and the bottom plate of the yoke to strengthen an intensity of the magnetic field.

11. The loudspeaker of claim 1, wherein the diaphragm is attached to an upper surface of the flange.

12. The loudspeaker of claim 11, wherein the diaphragm comprises a central area in a center thereof and a surrounding area at an outer periphery thereof.

13. The loudspeaker of claim 12, wherein one end of the voice coil is secured to a bottom of the annular inner joint portion, an opposite end of the voice coil is inserted into an annular gap between the side plate of the yoke and the magnet.

14. The loudspeaker of claim 12, wherein the diaphragm further comprises an annular outer joint portion formed around the diaphragm and connected with the surrounding area, the annular outer joint portion is pressed to the flange by a ring to secure the diaphragm to the flange.

15. A loudspeaker, comprising:
a frame, which comprises a flange and a supporting bracket, the flange comprising two parallel straight portions and two curve portions connected between the two parallel straight portions, respectively, the supporting bracket located inside the flange and defining a through hole in a center thereof;
a yoke engaged with the frame and at least partly received in the through hole of the supporting bracket;
a magnet fixed inside the yoke;
a diaphragm attached to the frame; and
a voice coil attached to the diaphragm.

16. The loudspeaker of claim 15, wherein the flange and the supporting bracket are integrally formed as a single monolithic piece of material.

17. The loudspeaker of claim 15, wherein the yoke comprising a circular bottom plate and a side plate extending upwardly from the bottom plate, the bottom plate and the side plate cooperatively define a receiving space to receive the magnet.

18. The loudspeaker of claim 17, wherein a platform is defined at a center of the bottom plate for positioning the magnet.

19. The loudspeaker of claim 17, wherein the through hole has a step-shape inner surface, a free end portion of side plate of the yoke has a step-shape structure, corresponding to the step-shaped inner surface of the main body at the through hole.

20. A loudspeaker, comprising:
a frame, which comprises a flange and a supporting bracket, the flange having an athletics track-shaped structure, the supporting bracket located inside the flange and defining a through hole in a center thereof;
a yoke engaged with the frame and at least partly received in the through hole of the
supporting bracket;
a magnet fixed inside the yoke;
a diaphragm attached to the frame; and
a voice coil attached to the diaphragm.
